(19) United States
(12) Patent Application Publication
(10) Pub. No.: US 2020/0076361 A1
(43) Pub. Date: Mar. 5, 2020

(54) 'Online' air cleaning assembly with control logic for air cleaning assembly

(71) Applicants: Varun Jonnalagadda Krishna, Chappaqua, NY (US); Rajnikant Jonnalagadda, Ridgecrest, CA (US)

(72) Inventors: Varun Jonnalagadda Krishna, Chappaqua, NY (US); Rajnikant Jonnalagadda, Ridgecrest, CA (US)

(21) Appl. No.: 16/120,240

(22) Filed: Sep. 1, 2018

(51) Int. Cl. H02S 40/10; B08B 5/02; H02S 30/10

(52) U.S. Cl. CPC H02S 40/10; H02S 30/10; B08B 5/02

(57) ABSTRACT

This invention is related to the need for cleaning Solar Panels (Photovoltaic or PV) that are operating to generate voltages and related power through the day. As part of this invention, an ‘online cleaning’ system has been designed that would use an appropriately sized air compressor for producing compressed air, to frequently clean the surface of the operating solar panels throughout the day/night period. The frequency of ‘online cleaning’ would be determined by a user specified timer that in turn would automatically drive a solenoid valve to turn the air compressor on/off.

### BACKGROUND

1. Renewable Renewable energy is energy that is collected from renewable resources, which are naturally replenished on a human timescale, such as sunlight, wind, rain, tides, waves, and geothermal heat.

2. Renewable energy often provides energy in four important areas: electricity generation, air and water heating/cooling, transportation, and rural (off-grid) energy services.

3. Based on REN21's 2016 report, renewables contributed 19.2% to humans' global energy consumption and 23.7% to their generation of electricity in 2014 and 2015, respectively. This energy consumption is divided as 8.9% coming from traditional biomass, 4.2% as heat energy (modern biomass, geothermal and solar heat), 3.9% hydro electricity and 2.2% is electricity from wind, solar, geothermal, and biomass. Worldwide investments in renewable technologies amounted to more than US$286 billion in 2015, with countries like China and the United States heavily investing in wind, hydro, solar and biofuels. Globally, there are an estimated 7.7 million jobs associated with the renewable energy industries, with solar photovoltaics being the largest renewable employer.

4. As of 2015 worldwide, more than half of all new electricity capacity installed was renewable.

5. Renewable energy resources exist over wide geographical areas, in contrast to other energy sources, which are concentrated in a limited number of countries. Rapid deployment of renewable energy and energy efficiency is resulting in significant energy security, climate change mitigation, and economic benefits.

6. The results of a recent review of the literature concluded that as greenhouse gas (GHG) emitters begin to be held liable for damages resulting from GHG emissions resulting in climate change, a high value for liability mitigation would provide powerful incentives for deployment of renewable energy technologies. In international public opinion surveys there is strong support for promoting renewable sources such as solar power and wind power.

7. At the national level, at least 30 nations around the world already have renewable energy contributing more than 20 percent of energy supply. National renewable energy markets are projected to continue to grow strongly in the coming decade and beyond.

8. Some places and at least two countries, Iceland and Norway generate all their electricity using renewable energy already, and many other countries have the set a goal to reach 100% renewable energy in the future.
a. For example, in Denmark the government decided to switch the total energy supply (electricity, mobility and heating/cooling) to 100% renewable energy by 2050.

9. While many renewable energy projects are large-scale, renewable technologies are also suited to rural and remote areas and developing countries, where energy is often crucial in human development Former United Nations Secretary-General Ban Ki-moon has said that renewable energy has the ability to lift the poorest nations to new levels of prosperity.

10. As most of renewables provide electricity, renewable energy deployment is often applied in conjunction with further electrification, which has several benefits: Electricity can be converted to heat (where necessary generating higher temperatures than fossil fuels), can be converted into mechanical energy with high efficiency and is clean at the point of consumption.

11. In addition to that electrification with renewable energy is much more efficient and therefore leads to a significant reduction in primary energy requirements, because most renewables don't have a steam cycle with high losses (fossil power plants usually have losses of 40 to 65%).

12. Renewable energy systems are rapidly becoming more efficient and cheaper. Their share of total energy consumption is increasing. Growth in consumption of coal and oil could end by 2020 due to increased uptake of renewables and natural gas.

### BRIEF DESCRIPTION OF DRAWINGS

FIG. 1 is an overview of the roller on the solar panels themselves, as well as the air holes on the cleaner.

FIG. 2 is a blueprint of how the controller will work, and what it controls.

### DETAILED DESCRIPTION OF DRAWINGS

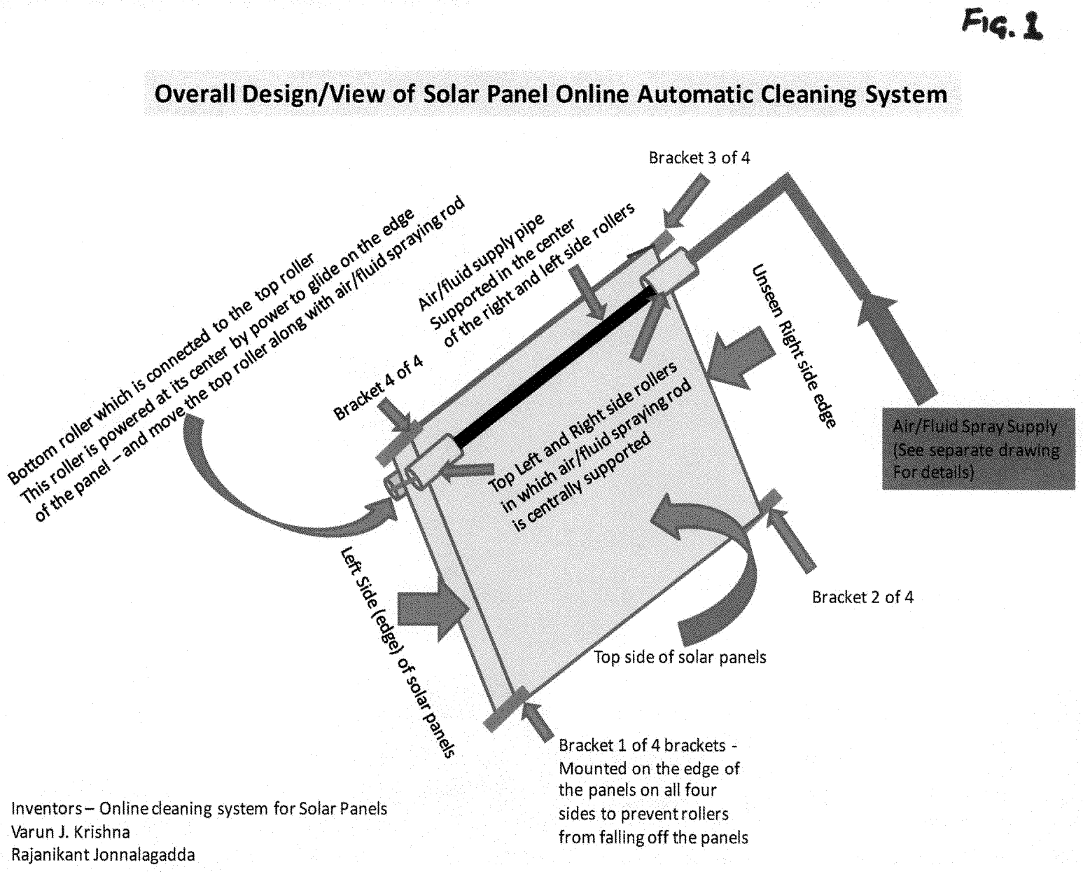

FIG. 1: This image includes diagrams on, a side view of how the rollers will be attached to the solar panels (View AA), a view of the pipe with its air holes (View AB), as well as a birds' eye view of the roller and pipe on the solar panels. These are all diagrams to help show how the cleaning system will work, with the air holes providing pressurized air directed at the panels in order to help keep the panels cleaned. View ‘AA’ is the proposed way of how the rollers will be attached to the panels, by having one part below, and one above on the side of the panels. The rollers will proceed up and down the panels ensuring that the whole panel is cleaned.

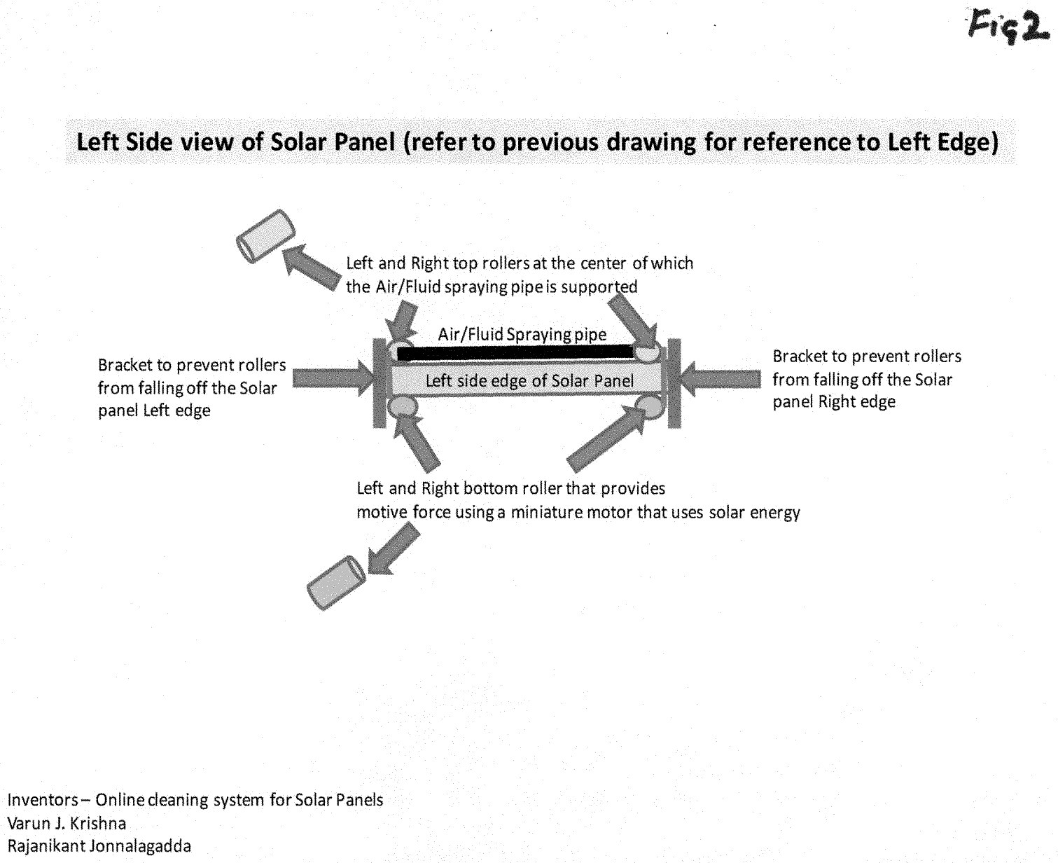

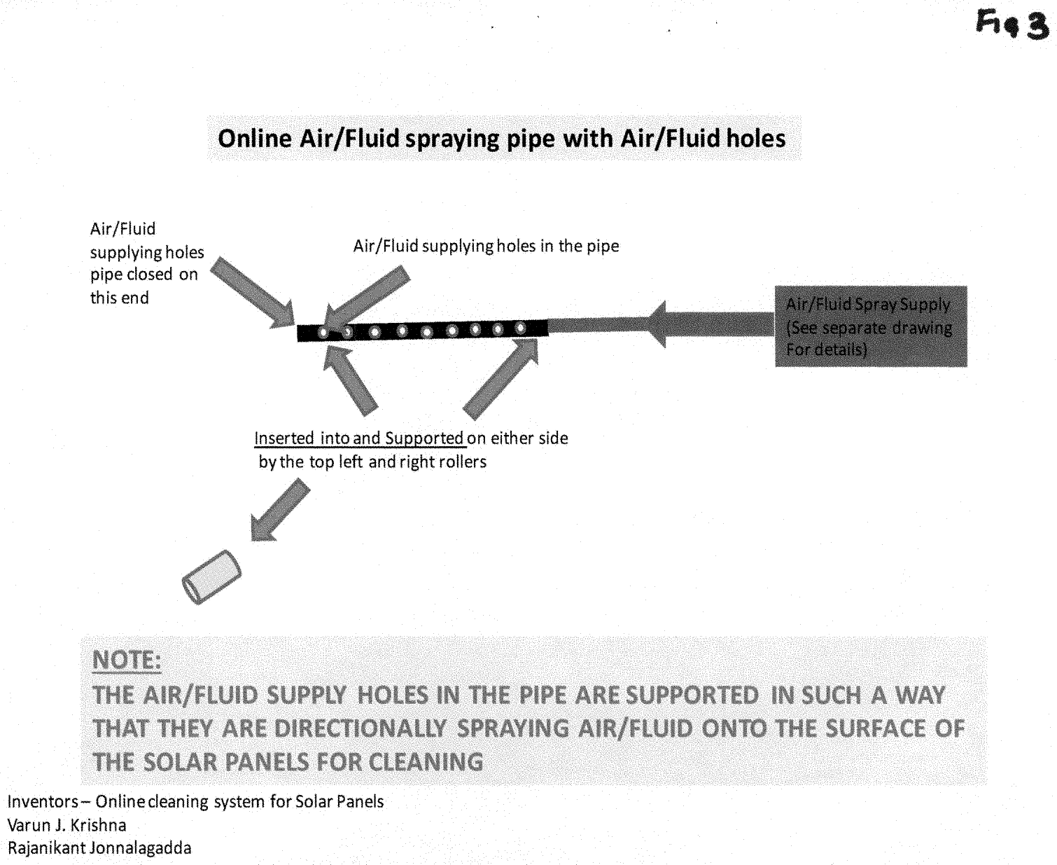

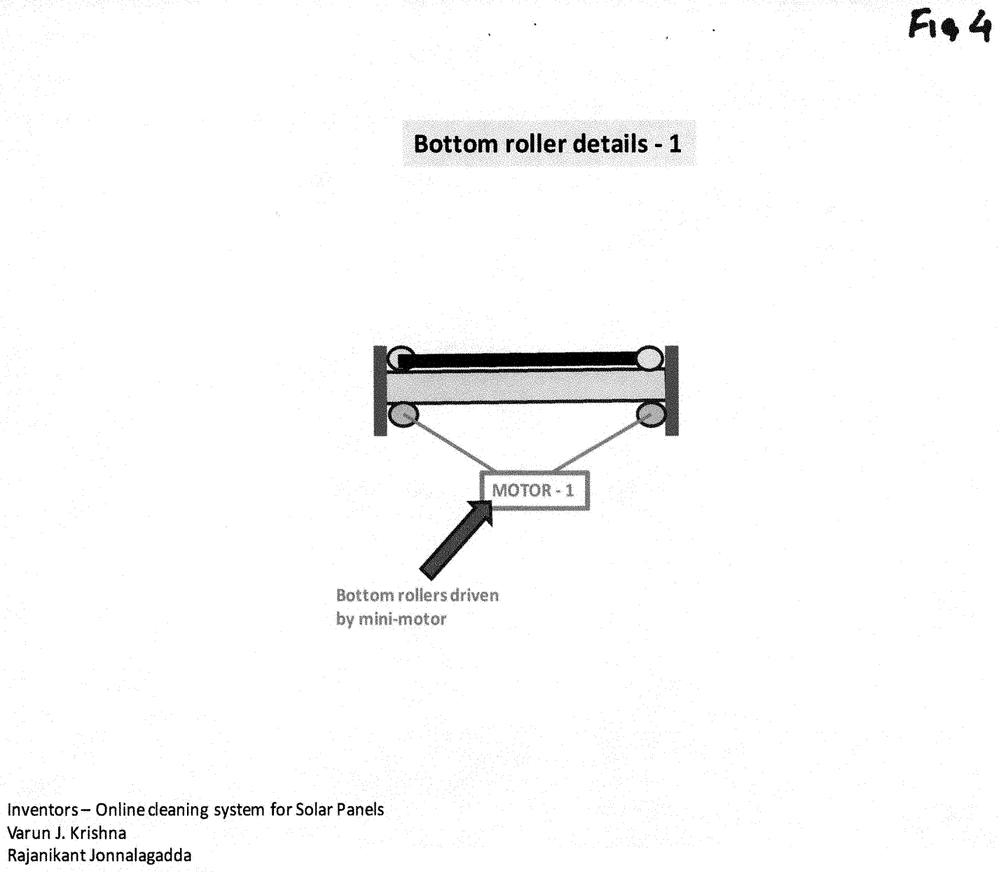

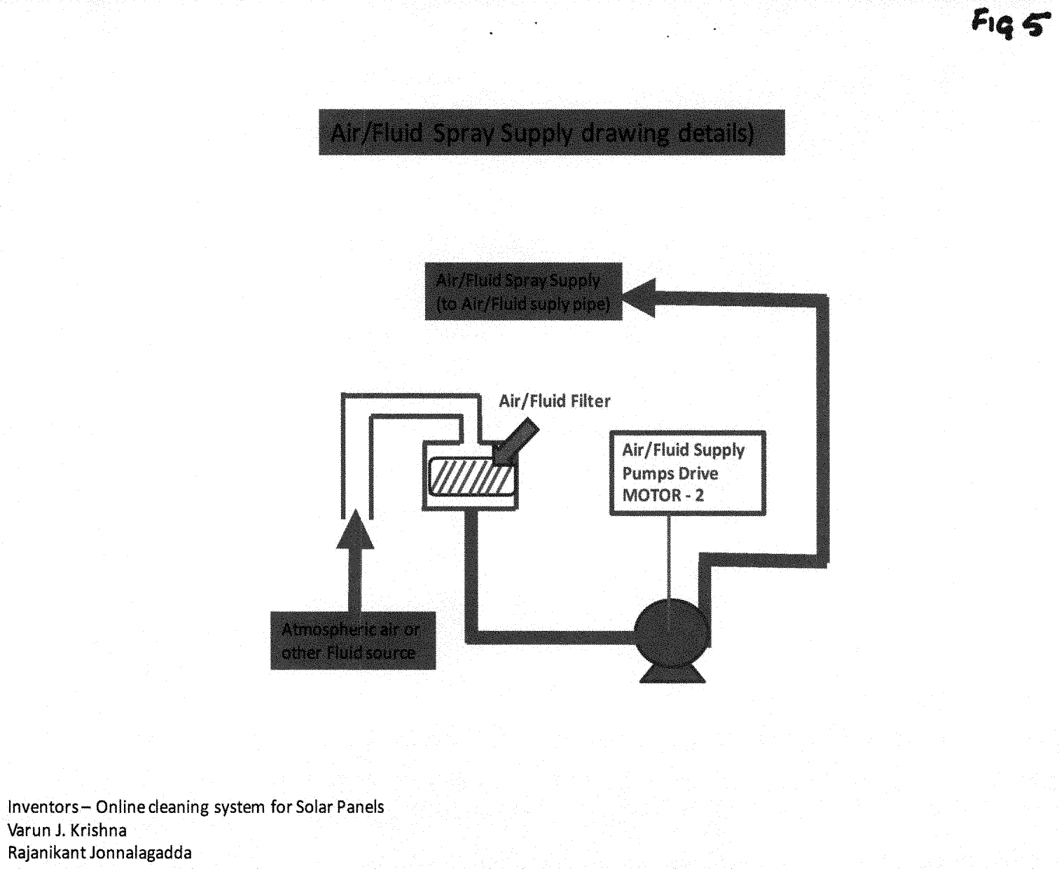

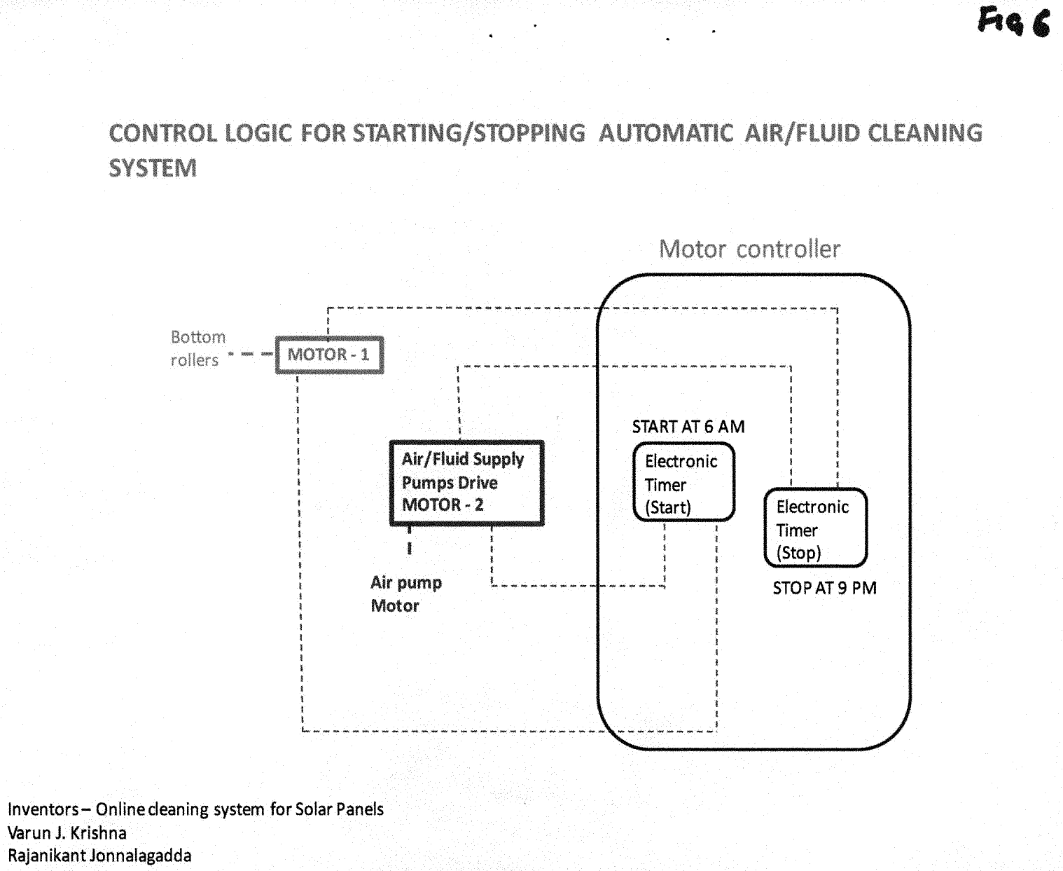

FIG. 2: This figure provides a description of the control logic for the air cleaning assembly. This includes a drawing of the motor controller with its buttons, with (dash lines) connected to the element of the system which it has control over. The controller will also contain an electronic timer which the user can set however they may please for how often the pipe cleans the panels. The pressurized air will travel from the atmosphere through the air compressor, and the through the air supply flexible tube and then come out of the air holes on the cleaning pipe.

A Designed Experiment was Set Up Using the Following Components:
i. A DC voltage and associated power generating PV solar panel system
   1. Thunderbolt solar panels (4×25 watts; 12 Volts)
ii. Cables to connect the solar panels to a charge controller—that would manage the increasing current from the increasing voltage to users
iii. Two users
   1. Two 12V, 100 Watt LED bulbs
   2. One 12 Volt, 35 Amp-Hr rechargeable battery to ensure that the day time solar panel voltage associated power would be used to store the same to drive night time operation of the user needs (in this case the two LED bulbs described in item iii) 1 above
iv. A laser device to measure the surface temperatures of the solar panels throughout the day
v. A charge controller that not only managed the charge for increasing voltages from the solar panels but also measured the voltage being generated by the solar panels throughout the day and night and also the voltage being sent to the users
vi. A voltage meter to independently measure the voltage to and from the charge controller (these readings matched the readings from the charge controller)
vii. Ambient temperatures throughout the day as provided by the local weather station in Ridgecrest, Calif.

b. Microsoft Excel tool was used to log the operator readings throughout the day

c. Minitab 18 was used to analyze the results from the readings taken

### Results and Discussion

d. Results from Designed Experiments using a domestic solar panel have revealed that the angle of tilt and continuous cleaning of the surface of solar panels have a statistically significant effect on the generated voltage from the solar panels going into a charge controlled (which is used to send the charge to users). As a result of ‘online cleaning’, the average voltage increase from the solar panels is approximately 8% when compared to a baseline that includes average voltage readings from unclean, tilting solar panels

e. The inventors used these results and developed a design for an ‘online cleaning’ device that uses compressed air delivered to the surface of the solar panels. This ‘online cleaning’ device will move along the breadth of the solar panels on rollers that are mounted on both ends of the solar panel edges, spraying pressurized air to clean the surface and maintain efficiency of the solar panels in generating potential and related power. The frequency of movement of the ‘online cleaning’ device would be controlled by an automatic timer that would in turn drive the air compressor motor start/stop at preset timer frequencies (set by customers who use solar panels to drive potential and associated power to users)

1. An ‘online’ solar panel cleaning device.

2. The ‘online’ solar panel cleaning device of claim 1, wherein the device comprises:
a. an air supply component mounted on the device
b. an air compressor attached to the air supply component mounted on the solar panel; said compressor driven by a motor;
c. An automated timer device that is attached to said motor of the air compressor, controlling the frequency of which the compressor supplies air to the solar panel mounted ‘online’ cleaning device;
d. An auto motor start/stop switch attached to said air compressor, where said timer device is user-configured to start and stop the air supply for ‘online’ solar panel cleaning
